(19) United States
(12) Patent Application Publication
(10) Pub. No.: US 2026/0140729 A1
(43) Pub. Date: May 21, 2026

(54) METHOD, DEVICE, AND STORAGE MEDIUM FOR PROCESSING CONFIGURATION UPDATE

(71) Applicant: Lenovo Enterprise Solutions (Singapore) Pte. Ltd., Singapore (SG)

(72) Inventors: Fred Allison Bower, III, Durham, NC (US); Charles C. Queen, Apex, NC (US); Caihong Zhang, Shanghai (CN); He Huang, Shanghai (CN)

(21) Appl. No.: 19/116,904

(22) PCT Filed: Jul. 20, 2023
(86) PCT No.: PCT/CN2023/108349

§ 371 Date: Mar. 28, 2025

(51) Int. Cl. G06F 8/65

(52) U.S. Cl. CPC G06F 8/65

(57) ABSTRACT

a method for processing a unified-extensible-firmware-interface (“UEFI”) configuration file update in a computing device storing a configuration data file is provided. The method includes receiving a UEFI configuration update file, the UEFI configuration update file including an update data entry, an update data entry label corresponding to the update data entry, and an update question identifier corresponding to the update data entry; determining whether the update data entry label matches any data entry label in the configuration data file stored in the computing device; determining whether the update question identifier matches a question identifier in the configuration data file stored in the computing device; and uploading the update data entry into the computing device once a match is found.

### TECHNICAL FIELD

The present disclosure relates to the technical field of unified-extensible-firmware interface (“UEFI”) configuration update.

### BACKGROUND

Firmware provides an interface between hardware and an operating system (OS). In general, there are two types of firmware, namely device firmware for controlling a peripheral device, and system firmware or platform firmware for system control.

The system firmware is often stored in a non-volatile memory (“NVRAM”). A well-known system firmware interface is the BIOS (Basic Input/Output System). The unified extensible firmware interface (“UEFI”) has emerged as a system firmware interface that is used as a replacement of the BIOS firmware interface.

### SUMMARY

One aspect of the present disclosure provides a method of processing a unified-extensible-firmware-interface (“UEFI”) configuration update in a computing device including a memory and processor coupled to the memory, the method including: receiving a UEFI configuration update file, the UEFI configuration update file including an update data entry, an update data entry label corresponding to the update data entry, and an update question identifier corresponding to the update data entry; determining whether the update data entry label matches any data entry label in the configuration data file stored in the computing device; determining whether the update question identifier matches a question identifier in the configuration data file stored in the computing device; and an uploading the update data entry into the computing device once a match is found.

Another aspect of the present disclosure provides a computing device including a memory and a processor coupled to the memory, the processor being configured to perform the method for processing the UEFI configuration file update. The method includes: receiving a UEFI configuration update file, the UEFI configuration update file including an update data entry, an update data entry label corresponding to the update data entry, and an update question identifier corresponding to the update data entry; determining whether the update data entry label matches any data entry label in the configuration data file stored in the computing device; determining whether the update question identifier matches a question identifier in the configuration data file stored in the computing device; and uploading the update data entry into the computing device once a match is found.

Another aspect of the present disclosure provides a non-transitory computer-readable storage medium storing computer program instructions executable by a processor to perform a method for processing a unified-extensible-firmware-interface (“UEFI”) configuration update. The method includes: receiving a UEFI configuration update file, the UEFI configuration update file including an update data entry, an update data entry label corresponding to the update data entry, and an update question identifier corresponding to the update data entry; determining whether the update data entry label matches any data entry label in the configuration data file stored in the computing device; determining whether the update question identifier matches a question identifier in the configuration data file stored in the computing device; and uploading the update data entry into the computing device once a match is found.

### BRIEF DESCRIPTION OF THE DRAWINGS

For a more complete understanding of the embodiments of the present disclosure and associated advantages, reference will now be made to the following description in conjunction with the accompanying drawings.

FIG. 1 is a schematic diagram of a computing device according to one embodiment of the present disclosure.

FIG. 2 is a schematic diagram of a UEFI database according to another embodiment of the present disclosure.

FIG. 3 is a schematic diagram of a method flow chart according to yet another embodiment of the present disclosure.

FIG. 4A is a schematic diagram according to yet another embodiment of the present disclosure.

FIG. 4B is a schematic diagram according to yet another embodiment of the present disclosure.

FIG. 5 is a schematic diagram of a method flow chart according to yet another embodiment of the present disclosure.

### DETAILED DESCRIPTION OF THE EMBODIMENTS

In view of the descriptions to the following embodiments of the present disclosure in conjunction with the accompanying drawings, aspects, advantages, and prominent features of the present disclosure will become readily apparent to those skilled in the art.

Various embodiments described below are merely illustrative and should not be construed as limiting the scope of the disclosure in any particular way. The following description with reference to the accompanying drawings is to assist in a comprehensive understanding of exemplary embodiments of the present disclosure as defined by the claims and their equivalents. The following description includes a variety of specific details; but these details should be considered as exemplary and illustrative only. Accordingly, those of ordinary skill in the art should recognize that various changes and modifications may be made to the embodiments described herein without having to deviate from the scope and spirit of the present disclosure. Descriptions of well-known functions and constructions are omitted for clarity and brevity. In addition, the same reference numerals are used for the same or similar functions and operations throughout the drawings. In addition, although schemes with different features may be described in different embodiments, those skilled in the art should realize that all or part of the features of different embodiments may be combined to form an embodiment without departing from the spirit and scope of the present disclosure.

Firmware provides an interface between hardware and an operating system (OS). Basic Input/Output System (BIOS) firmware interface is a system firmware interface that enables the BIOS system initiations after a power supply is activated or during runtime. The unified extensible firmware interface (UEFI) is a firmware interface which has been used as a replacement of the BIOS firmware interface. UEFI is a specification that defines a software interface between an operating system and platform software. UEFI can be used to support remote diagnostics and repairs of computers, even with no operating system installed.

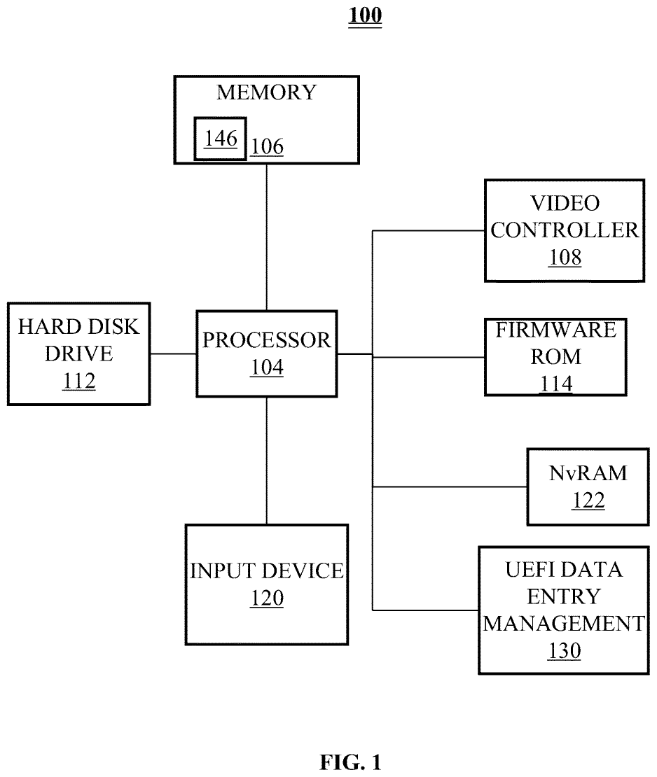

When a computer system receives a firmware update, the computer system may need to update some or all configuration data entries. A computer system may apply heuristics to tolerate the changes to the data entries. For example, during a system update, a system such as a computing device referenced in FIG. 1 may issue a warning when a defined data entry in a system update configuration file does not match any existing names or descriptive strings labeling the data entries. The system may force user interventions by rejecting any settings being programmed if the data entry mappings are not completely compatible. Further, in this type of processes, the system being updated would not recognize the issue until it attempts to apply an updated configuration. Such delays often lead to misdiagnosis of what is a simple configuration problem.

UEFI Human Interface Infrastructure (HII) defines the core code and services to describe the data and Application Programming Interfaces (API) used to manage the system's firmware configuration. This includes basic mechanisms for managing user input and code definitions for related protocols. UEFI can include an HII database and corresponding protocols to support the storage and manipulation of configuration information associated with UEFI compliant devices included. UEFI specification provides a standardized way in which firmware can communicate with a user or application software concerning firmware related settings.

HII questions are statements which have a value. The value corresponds to a configuration setting for the platform or for a device. The question uniquely identifies the configuration setting, describes the possible values, the way the value is stored, and or how the question is displayed.

In addition to the value, the HII questions may further include a question identifier. In certain embodiments, the question identifier is a 16-bit unsigned integer which uniquely identifies the question within the form set in which it appears. The question identifier, along with the device path and form set identifier, uniquely identifies a question within a system.

Each configuration setting can be associated with an HII question. An HII question is a type of HII statement that has a value, and the value corresponds to a configuration setting for the server such as the computing device 100 referenced in FIG. 1. A form, which may be included in a forms package, may present one or more questions and an interface though which a user or an application program can select between a set of provided configuration options. For example, an HII question may represent an option to enable or disable a Universal Serial Bus (USB) port. HII questions are uniquely identified within an HII form set using a respective question identifier. The question identifier, along with a UEFI device path, and a form set identifier (typically a globally unique identifier (GUID)), uniquely identifies a configuration setting within the computer system that is being updated. This set of identifiers is used by the UEFI to administer device configuration settings.

Every UEFI entry has a descriptive text string, which may alternatively be referred to as a data entry label of the UEFI data entry. This is used by the firmware when it is presenting a menu to users. For example, instead of “Hard drive 0” and “USB drive 3”, the firmware can display “Windows Boot Manager” and “Red Hat Linux” in a user interface. In embodiments consistent with the present disclosure, a system management software may compare a data entry label against “Windows Boot Manager” and decide whether the UEFI data entry is a match.

In embodiments of the present disclosure, a firmware vendor may set the question identifier (e.g., an UEFI HII question identifier) for each configuration data entry consistently across different firmware versions. For example, a UEFI firmware configuration parameter X may be labelled as “Data Entry A” in firmware version 1. In firmware version 2, the label for configuration parameter X may be changed to “Data Entry A1.” However, the question identifier for configuration parameter X may remain unchanged as “Q0001” in both firmware version 1 and firmware version 2. Therefore, the question identifier may be used to correlate the labels for “Data Entry A” and “Data Entry A1” in firmware versions 1 and 2 when the system is being updated.

As an alternative to using the UEFI question identifier as the means of disambiguation, the present disclosure in one or more embodiments may further implement a method of partial matching to match the data entry labels of the configuration data entries. Implementing the partial matching, in some embodiments, the system may compare between the data entry labels of the set of parameters in a stored configuration profile and the data entry labels of a set of configuration parameters from a firmware update. In one example, if the data entry label of one configuration data entry in the stored profile does not match any data entry label of the configuration data entry in the firmware update, the system may check whether the unmatched configuration data entry is at the same position of the configuration data set. If so, the one configuration data entry in the stored profile and the one configuration parameter in the firmware updated system profile may be a partial match.

FIG. 1 is a schematic diagram of firmware and hardware components of a computing device 100 according to one or more embodiments of the present disclosure. The computing device 100 may include a processor 104, a memory 106, a computer readable storage medium 146, a video controller 108, a hard disk drive (HDD) 112, a firmware ROM 114, an input device 120, a non-volatile RAM (NvRAM) 122, and a UEFI 130. The processor 104 is connected to the hard disk drive (HDD) 112, the firmware ROM 114, and the non-volatile RAM (“NVRAM”) 122. The processor 104 may be a central processing unit (CPU), a digital signal processor (DSP), a microcontroller unit (MCU), a neural network processor/accelerator, among others. The processor 104 may be a single processing unit or multiple processing units for executing different actions of the methods and/or processes described herein.

The computing device 100 may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, or other purposes. For example, the computing device may be a personal computer, a network storage device, or any other suitable device and may vary in size, shape, performance, functionality, and price.

In embodiments consistent with the present disclosure, the computing device 100 is substantially compliant with one or more revisions of the UEFI specification. The computing device 100 includes UEFI data entry management system 130. UEFI is similar to the basic input/output system (BIOS) often found in older computing devices. The UEFI specification provides standard interfaces and interoperability guidelines for devices that together make up an information handling system. In particular, the UEFI specification describes an interface between an operating system and platform firmware, including data structures and protocols to manage initialization of devices, booting of platform resources, and passing of control to the operating system.

The UEFI specification allows for the extension of platform firmware by loading UEFI driver and UEFI application profiles. For example, an original equipment manufacturer can include customized or proprietary profiles to provide enhanced control and management of the computing device 100.

The memory 106 stores configuration information compliant with UEFI. During initialization, the UEFI data entry management system 130 wakes up system firmware of the computing device 100, to detect, examine, and initialize components such as the processor 104 and the memory 106 of the computing device 100. The UEFI data entry management system 130 may boot a UEFI supported OS from the HDD 112. The HDD 112 is a boot device that stores a boot image. The HDD 112 may have different partitions and may store a different boot image at each partition. For example, one partition may store a boot image of the UEFI supported OS, and another partition may store a boot image of an OS not supporting UEFI.

In one example, when the power is turned on, the computing device 100 may begin a sequence of initialization procedures. During the initialization sequence, also referred to as a boot sequence, components of the computing device 100 are configured and enabled for operation, and auxiliary drivers may be installed. In some embodiments, UEFI data entry management system 130 may execute a firmware when the system is turned on. For example, the configuration update may involve a dispatch of a new version of firmware which includes a configuration data entry X with a descriptive string or a data entry label AA. In an existing UEFI data table or configuration profile stored at the computing device 100, the same configuration data entry has a different data entry label AB. The UEFI data entry management system 130 may then check the UEFI question identifier of data entry X. The UEFI data entry management system 130 may identify the stored data entry based on the UEFI question identifier if the UEFI question identifier of the update configuration data entry X matches the corresponding UEFI question identifier in the configuration profiled stored in computing device 100, and the computing device 100 may determine that the data entry X with a data entry label AA in the firmware update is the same data entry that is labeled as AB in the stored configuration profile. The UEFI data entry management system 130 would then load the data entry X of the new firmware update, even though in this scenario, the data entry labels do not match completely.

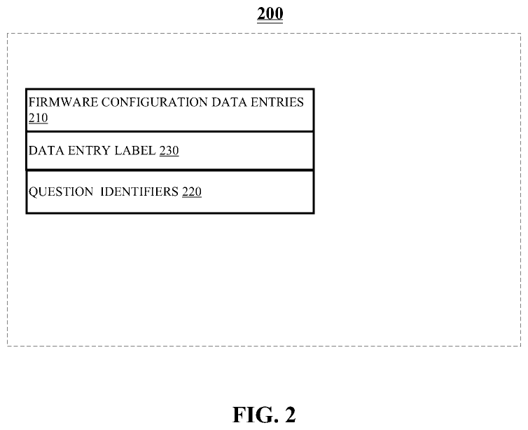

FIG. 2 shows a UEFI database 200 that may be stored at the UEFI data entry management system 130 and/or at the memory 106. The UEFI database 200 may include a set of firmware configuration data entries 210, a set of data entry labels 230, and a set of question identifiers 220. In embodiments consistent with the present disclosure, other data structures may also be used to correlate data entry labels, question identifiers, and configuration data entries.

At any given time, the computing device 100 may update certain firmware. Accordingly, values of the configuration data entries may be updated to reflect such firmware changes. In some instances, the description of a configuration data entry or the label of the configuration data entry may be updated. The configuration data updates may be applied during a UEFI initialization of the computing device 100.

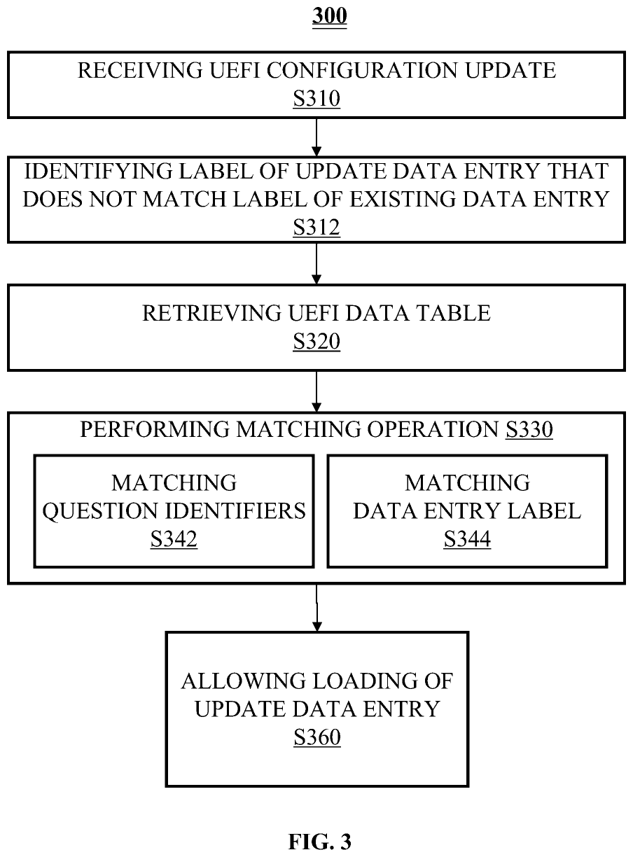

FIG. 3 is a schematic flow chart of a method 300 of processing a UEFI configuration data update in a device, such as the computing device 100 of FIG. 1, according to one or more embodiments of the present disclosure. As illustratively depicted in FIG. 3, the method 300 may include step 310, step 312, step 320, step 330, and step 360. Step 330 includes one or both of steps 342 and 344.

At step 310, the UEFI data entry management system 130 of computing device 100 may receive a UEFI firmware configuration update file. Each of the data entries in the UEFI firmware update file may include or be associated with a data entry value, a data entry label, and a question identifier.

At step 312, the UEFI data entry management system 130 may identify that an update configuration data entry has a data entry label (or data entry description) that does not match the data entry label in the stored configuration profile or a UEFI data table such as database 200 referenced in FIG. 2 for that data entry.

At step 320, the UEFI data entry management system 130 may retrieve from its memory 106 a UEFI data table such as the database 200 referenced in FIG. 2. The UEFI data table may correlate configuration data entries with data entry labels and question identifiers.

At step 330, the UEFI data entry management system 130 via the processor 104 may perform a matching operation. By checking the UEFI data table, the UEFI data entry management system 130 may check the question identifier of the data entry with the unmatched data entry label to determine whether the unmatched data entry corresponds to the data with the same question identifier in the stored configuration profile. Once the UEFI data entry management system 130 identifies the data entry based on the question identifier, it may then determine that the data entry with unmatched data entry label in the firmware update is the same data entry that corresponds to a different data entry label in the stored profile.

In some embodiments, the UEFI data entry management system 130 may apply a partial text matching method to determine whether the unmatched data entry label is similar to a corresponding data entry label in the stored configuration profile. Step 342 and/or step 344 may be executed to accomplish the matching tasks according to method 300.

At step 342, the UEFI data entry management system 130 may check the question identifiers of the UEFI data table to find a match of the update question identifier. In one embodiment, a match may be found when an existing question identifier and the update question identifier are the same.

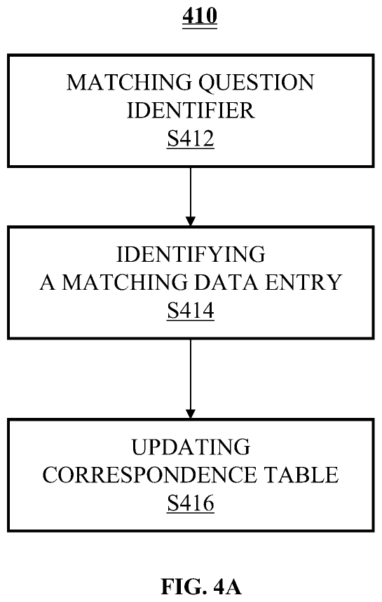

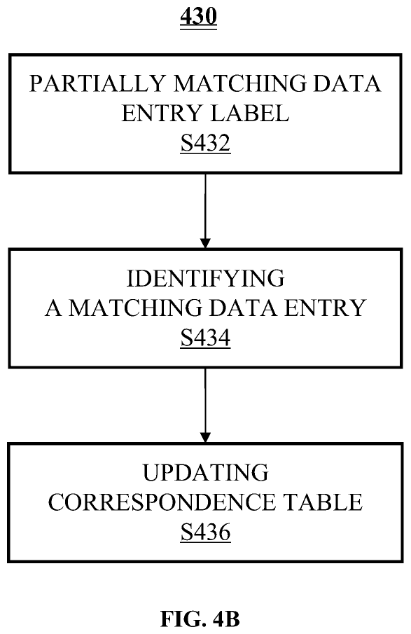

At step 344, the UEFI data entry management system 130 may screen the data entry labels of the UEFI table to match the update data entry involved in the configuration update, a match or partial match may be found when the difference between a data entry label of the existing data entry and the update data entry label of the update data entry meets a preset criteria, which is further discussed in FIG. 4B.

At step 360, once a match is found in step 330, the computing device 100 may allow the update data entry in the configuration update to be loaded. In other words, the computing device 100 may load the data entry with the “unmatched” data entry label identified in step 312.

FIG. 4A is a schematic diagram of additional processing steps executable at step 342 of FIG. 3. FIG. 4B is a schematic diagram of additional processing steps executable at steps 344 of FIG. 3.

The sub-process 410 of FIG. 4A starts at step 412, when there is a difference between the data entry label or description of the stored configuration data entry and the data entry label or description of the update data entry, the UEFI data entry management system 130 may find a match of the question identifier of the update data entry and the stored configuration data entry. At step 414, the UEFI data entry management system 130 may locate from the UEFI data table a matching data entry corresponding to the matching question identifier. At step 416, the UEFI data entry management system 130 may add to or update the UEFI table to include the data entry label corresponding to the matched question identifier.

The sub-process 430 of FIG. 4B starts at step 432, when there is a difference between the data entry label or description of the existing data entry and the data entry label or description of the update data entry, and the UEFI data entry management system 130 further has not identified a matching question identifier. At step 432, the UEFI data entry management system 130 may partially match the data entry label corresponding to the update data entry with a data entry label of a stored configuration data entry. For example, if the data entry label of the update data entry contains more than 90% of the letters or symbols of the data entry label of a stored configuration data entry, the UEFI data entry management system 130 may determine that the data entry label is a partial match. At step 434, the UEFI data entry management system 130 may locate the data entry corresponding to the partially matched data entry label, and identify it as the matching data entry. At step 436, UEFI data entry management system 130 may update the UEFI data table based on the matching results found at step 434.

According to one or more embodiments of the present disclosure, a match or partial match may be found when one or more of the defined match rules are met by the UEFI data entry management system 130. In certain embodiments, the update question identifier or the question identifier in the configuration data file is a unique 16-bit unsigned integer for an exact match. In certain other embodiments, the UEFI configuration update file does not include the unique 16-bit unsigned integer, a partial match may be employed in the method of processing the UEFI configuration file update.

Table 1 titled “Partially Matching Rules” tabulates exemplary matching rules 1, 2, 3, 4, and 5 for data entry labels. In some embodiments, and to increase matching stringency, a matching rule may be created to the effect that matching is not found until any two of the matching rules 1, 2, and 3 are concurrently met. This may be termed matching rule 4 in Table 1. In certain other embodiments, a matching rule may be created to the effect that a match is not found until three of the other matching rules are met. This is termed matching rule 5 in Table 1. Table 2 provides a few examples of partial matches for data entry labels.

TABLE 1
Partially Matching Rules

| Matching rule | Description |
|---|---|
| Matching rule 1 | A match is found when no less than X % of all different letters in the |
| | existing data entry label are present in the update data entry label, where |
| | X is any suitable numeric number, such as 80, 85, 90, and 95. |
| Matching rule 2 | A match is found when no less than X % of all different numbers in the |
| | existing data entry label are present in the update data entry label, where |
| | X is any suitable numeric number, with non-limiting examples of which |
| | including 80, 85, 90, and 95. |
| Matching rule 3 | A match is found when no less than X % of all different (non-letter-non- |
| | number) symbols in the existing data entry label are present in the update |
| | data entry label, where X is any suitable numeric number, with non- |
| | limiting examples of which including 80, 85, 90, and 95. |
| Matching rule 4 | A match is found only when any two of the matching rules 1, 2, and 3 are |
| | concurrently met. |
| Matching rule 5 | A match is found only when all three of the matching rules 1, 2, and 3 are |
| | concurrently met. |

TABLE 2
Data Entry Label Partially Matching Examples

| Ex. | Existing Data Entry | Update Data Entry | Matching | Matching | Matching | Matching | Matching |
|---|---|---|---|---|---|---|---|
| No. | Label | Label | rule 1 | rule 2 | rule 3 | rule 4 | rule 5 |
| 11 | Boot method 1$ | Boot method 12$% | Y | Y | Y | Y | Y |
| 12 | Boot method 13$ | Boot method 12$% | Y | N | Y | Y/N | N |
| 13 | Boot methodology 1 | Boot method 12 | N | Y | Y | Y/N | N |

In Example 11, X=80 in matching rules, the existing data entry label “Boot method 1$” includes 10 letters, of which 7 are unique letters; therefore, more than 80 percent of all unique letters of “Boot method” are present in the update data entry label “Boot method 12$ %,” and accordingly the matching may be considered found under the matching rule 1.

In Example 11, the existing data entry label “Boot method 1$” includes one non-letter number, namely the number 1, and one non-letter-non-number symbol, namely the symbol $; therefore, no less than 80 percent of all non-letter numbers of the existing data entry label, namely the number 1, are present in the update data entry label “Boot method 12$ %,” and no less than 80 percent of all non-letter-non-number symbols of the existing data entry label, namely the symbol $, are present in the update data entry label “Boot method 12$ %,” and accordingly, matching rule 2 and matching rule 3 are also met in Example 11. Accordingly, matching rule 4 and matching rule 5 are met also.

In Example 12 of Table 2, X=80 in matching rules, the existing data entry label “Boot method 13$” includes 10 letters, of which 7 are unique letters, 2 non-letter numbers, and 1 non-letter-non-number symbol; therefore, no less than 80 percent of all unique letters of “Boot method” are present in the update data entry label “Boot method 12$ %,” and accordingly the matching may be considered found under the matching rule 1.

Referring back to Example 12, the existing data entry label “Boot method 13$” includes two non-letter numbers, namely the numbers 1 and 3, and one non-letter-non-number symbol, namely the symbol $; therefore, less than 80 percent of all non-letter numbers of the existing data entry label, namely the numbers 1 and 3, are present in the update data entry label “Boot method 12$ %,” accordingly, matching rule 2 is not met; and no less than 80 percent of all non-letter-non-number symbols of the existing data entry label, namely the symbol $, are present in the update data entry label “Boot method 12$ %,” and accordingly, matching rule 3 is met. Because the matching rule 2 is not met, matching rule 5 is not met either.

In Example 13 of Table 2, X=80 in matching rules, the existing data entry label “Boot methodology 1” includes 15 letters, of which 10 are unique letters, 1 non-letter number, and 0 non-letter-non-number symbol; therefore, less than 80 percent of all unique letters of “Boot methodology 1” are present in the update data entry label “Boot method 12$ %,” and accordingly the matching may not be considered found under the matching rule 1.

Referring back to Example 13, no less than 80 percent of all non-letter numbers of the existing data entry label, namely the number 1, is present in the update data entry label “Boot method 12,” accordingly, matching rule 2 is met; and there is no non-letter-non-number symbol in the existing data entry label, matching rule 3 is met. Because the matching rule 1 is not met, the matching rule 5 is not met either.

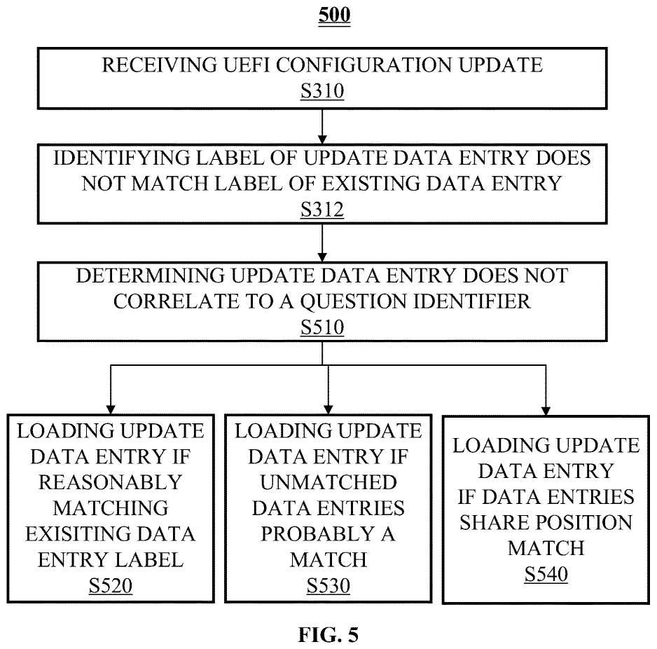

It is noted the rules presented in Table 1 is exemplary of and not intended to limit what a match or a partial match of a data entry label may be. Variations may be imparted into matching rules depending on specific requirements. By the same token, examples presented in Table 2 are merely illustrative of certain scenarios operable under the matching rules and are not intended to limit what a match or a partial match may include. FIG. 5 is a flow diagram of a method 500, as a variation to the method 300 of FIG. 3, for situations if and when the firmware update data entry does not have a matching question identifier, according to certain embodiments of the present disclosure. At step 510, the UEFI data entry management system 130 may determine that the question identifier of the update data entry does not match the question identifier of the stored configuration date entries. The computing device 100 may employ partial text matching to check the data entry labels. The partial text matching may be conducted according to any suitable matching rules, such as one or more rules detailed in Table 1 and Table 2.

At step 520, if the data labels such as the data label AB of the existing data entry and the data label AB of the update data entry are found to be matching, then the computing device 100 may load the update data entry.

At step 530, if the data labels do not meet the matching or partial matching criteria, the UEFI data entry management system 130 may further compare the set of data entries in the stored configuration profile with the set of data entries in the firmware update file. If there is only one data entry that is not matched in the stored configuration profile, and one data entry that is not matched in the firmware update file, then the UEFI data entry management system 130 may determine that the unmatched two data entries are a probable match. The computing device 100 may load the data entry in the firmware update.

At step 540, if the data labels are still not matched, the UEFI data entry management system 130 may then check the position of the data entry in the stored configuration profile, and the position of the unmatched data entry in the firmware update file. If the positions of the two unmatched data entries are the same (for example, they are both the third data entry under the root directory), then the computing device may match the data entries, and load the data entry. If all these processes do not match the update data entry, the computer device 100 may send an alert to the system administrator.

Referring back to FIG. 5, where steps 520, 530, and 540 are depicted to be in parallel positions relative to step 510, steps 520, 530, and 540 may be in any suitable order before and after each other. For example, step 520 may be positioned after step 510 but before steps 530 and/or 540, such that if a match according to step 520 is not found, then the method 500 then proceeds to steps 530 and/or 540. For example, step 530 may be positioned after step 510 but before steps 520 and/or 540, such that if a match according to step 530 is not found, then the method 500 then proceeds to steps 520 and/or 540. For example, step 540 may be positioned after step 510 but before steps 520 and/or 530, such that if a match according to step 540 is not found, then the method 500 may proceed to steps 520 and/or 530.

Referring back to FIG. 1, the computing device 100 may include at least one computer readable storage medium 146 in the form of a non-volatile or volatile memory, such as an electrically erasable programmable read-only memory (EEPROM), a flash memory, and/or a hard drive. The readable storage medium 146 includes computer program instructions (not shown) which in turn includes code/computer readable instructions that, when executed by the processor 104, cause the computing device 100 to execute the processes described above in conjunction with FIG. 2, FIG. 3, FIG. 4A. FIG. 4B, and any variations thereof.

As mentioned above, the processor 104 may be a single CPU (Central Processing Unit), but it may also include two or more processing units. For example, the processor 104 may include a general-purpose microprocessor, an instruction set processor, and/or an associated chipset, and/or a special purpose microprocessor, for example, an application specific integrated circuit (ASIC). The processor 104 may also include on-board memory for caching purposes. Computer program instructions may be carried out by a computer program instruction product connected to a processor. The computer program instruction product may include a computer-readable medium having computer program instructions stored thereon. For example, the computer program instruction product may be a flash memory, a random access memory (RAM), a read-only memory (ROM), and an EEPROM, and the above-mentioned computer program instruction module may be distributed to different computer program instruction products in the form of storage device included.

It should be noted that functions described in this article as being implemented by hardware components, and/or software components, and/or firmware may also be implemented via specific hardware components, specific software components, or a combination of hardware and software components, and the like. For example, functions described as being implemented through dedicated hardware (for example, Field Programmable Gate Array (FPGA), Application Specific Integrated Circuit (ASIC), and the like) may be processed by general-purpose hardware (for example, Central Processing Unit (CPU), digital signal processing) (DSP)) and software, and vice versa.

Although the present disclosure has been shown and described with reference to specific exemplary embodiments thereof, those skilled in the art will understand that, without departing from the spirit and scope of the present disclosure as defined by the appended claims and their equivalents, various changes in form and detail may be to the present disclosure. Therefore, the scope of the present disclosure should not be limited to the embodiments described above, but should be determined not only by the appended claims, but also by the equivalents of the appended claims.

What is claimed is:

1. A method of processing a unified-extensible-firmware-interface (“UEFI”) configuration file update in a computing device storing a configuration data file, the method comprising:
receiving a UEFI configuration update file, the UEFI configuration update file including an update data entry, an update data entry label corresponding to the update data entry, and an update question identifier corresponding to the update data entry;
determining whether the update data entry label matches any data entry label in the configuration data file stored in the computing device;
determining whether the update question identifier matches a question identifier in the configuration data file stored in the computing device; and
uploading the update data entry into the computing device once a match is found.

2. The method of claim 1, further comprising:
screening question identifiers of the configuration data file stored in the computing device and identifying a question identifier matching the update question identifier.

3. The method of claim 1, further comprising:
screening data entry labels of the configuration data file stored in the computing device and identifying a data entry label matching the update data entry label.

4. The method of claim 3, wherein a match is found when more than a percentage of all unique letters in the data entry label are present in the update data entry label.

5. The method of claim 3, wherein a match is found when more than a percentage of all unique numbers in the data entry label are present in the update data entry label.

6. The method of claim 3, wherein a match is found when more than a percentage of all unique symbols in the data entry label are present in the update data entry label.

7. The method of claim 3, wherein a match is found when a position of the update data entry in the update configuration file is the same as a position of a data entry in the configuration file stored in the computing device.

8. A computing device, comprising a memory and a processor coupled to the memory, the processor being configured to perform a method for processing a unified-extensible-firmware-interface (“UEFI”) configuration file update in a computing device storing a configuration data file, the method comprising:
receiving a UEFI configuration update file, the UEFI configuration update file including an update data entry, an update data entry label corresponding to the update data entry, and an update question identifier corresponding to the update data entry;
determining whether the update data entry label matches any data entry label in the configuration data file stored in the computing device;
determining whether the update question identifier matches a question identifier in the configuration data file stored in the computing device; and
uploading the update data entry into the computing device once a match is found.

9. The computing device of claim 8, wherein the method further comprising:
screening question identifiers of the configuration data file stored in the computing device and identifying a question identifier matching the update question identifier.

10. The computing device of claim 8, wherein the method further comprising:
screening data entry labels of the configuration data file stored in the computing device and identifying a data entry label matching the update data entry label.

11. The computing device of claim 10, wherein a match is found when more than a percentage of all unique letters in the data entry label are present in the update data entry label.

12. The computing device of claim 10, wherein a match is found when more than a percentage of all unique numbers in the data entry label are present in the update data entry label.

13. The computing device of claim 10, wherein a match is found when more than a percentage of all unique symbols in the data entry label are present in the update data entry label.

14. The computing device of claim 10, wherein a match is found when a position of the update data entry in the update configuration file is the same as a position of a data entry in the configuration file stored in the computing device.

15. A non-transitory computer-readable storage medium storing computer program instructions executable by a processor to perform a method for processing a unified-extensible-firmware-interface (“UEFI”) configuration file update in a computing device storing a configuration data file, the method comprising:
receiving a UEFI configuration update file, the UEFI configuration update file including an update data entry, an update data entry label corresponding to the update data entry, and an update question identifier corresponding to the update data entry;
determining whether the update data entry label matches any data entry label in the configuration data file stored in the computing device;
determining whether the update question identifier matches a question identifier in the configuration data file stored in the computing device; and
uploading the update data entry into the computing device once a match is found.

16. The computer-readable storage medium of claim 15, where in the method further comprising:
screening question identifiers of the configuration data file stored in the computing device and identifying a question identifier matching the update question identifier.

17. The computer-readable storage medium of claim 15, where in the method further comprising:
screening data entry labels of the configuration data file stored in the computing device and identifying a data entry label matching the update data entry label.

18. The computer-readable storage medium of claim 17, wherein a match is found when more than a percentage of all unique letters in the data entry label are present in the update data entry label.

19. The computer-readable storage medium of claim 17, wherein a match is found when more than a percentage of all unique numbers in the data entry label are present in the update data entry label.

20. The computer-readable storage medium of claim 17, wherein a match is found when more than a percentage of all unique symbols in the data entry label are present in the update data entry label.
